(19) United States
(12) Patent Application Publication
(10) Pub. No.: US 2024/0218961 A1
(43) Pub. Date: Jul. 4, 2024

(54) GIMBAL AND PHOTOGRAPHIC DEVICE STAND

(71) Applicant: Shenzhen Weiji Technology Co.,Ltd., Shenzhen (CN)

(72) Inventors: Qingqing ZOU, Shenzhen (CN); Wei WEI, Shenzhen (CN); Guodong ZHU, Shenzhen (CN); Jianxiong XIA, Shenzhen (CN)

(73) Assignee: Shenzhen Weiji Technology Co.,Ltd., Shenzhen (CN)

(21) Appl. No.: 18/212,272

(22) Filed: Jun. 21, 2023

(30) Foreign Application Priority Data
Dec. 29, 2022 (CN) 202223605917.3
Jan. 5, 2023 (CN) 202310013533.2

(51) Int. Cl. F16M 11/12; F16M 11/16; F16M 11/24; F16M 13/04; G03B 17/56

(52) U.S. Cl. CPC F16M 11/123; F16M 11/126; F16M 11/16; F16M 11/24; F16M 13/04; G03B 17/561

(57) ABSTRACT

A gimbal includes a base, a tilt mechanism, a pan mechanism, and a spherical mechanism. The base is provided with an external connection portion configured to connect a photographic device. The tilt mechanism includes a tilt body and a first connection rod. The tilt body is connected to the base and configured to tilt around the first connection rod. The pan mechanism includes a pan body and a second connection rod. The pan body is configured to pan around the second connection rod. The second connection rod is connected to a side wall of the first connection rod. The spherical mechanism includes a fixed body and a third connection rod. The fixed body is connected to the pan body and configured to rotate spherically on an upper end of the third connection rod. A lower end of the third connection rod is configured to connect an external stand.

### CROSS REFERENCE TO THE RELATED APPLICATIONS

This application is based upon and claims priority to Chinese Patent Applications No. 202223605917.3 filed on Dec. 29, 2022 and No. 202310013533.2 filed on Jan. 5, 2023, the entire contents of which are incorporated herein by reference.

### TECHNICAL FIELD

The present application relates to the technical field of photographic accessories, and in particular to a gimbal and a photographic device stand.

### BACKGROUND

With the development of social media, photographic devices such as digital single lens reflex (DSLR) cameras and mobile phones are increasingly appearing in people's daily lives. Photographic accessories play a crucial role in the quality of the photographic work. In shooting operations, the photographic device is stabilized through a gimbal and a tripod. The photographic device is mounted on the gimbal, and the gimbal is rotatably mounted on the tripod and can drive the photographic device to rotate relative to the tripod so as to adjust the shooting angle.

A precise shooting angle is important for further improving the quality of photographic works. However, at present, the adjustment range of the shooting angle and the assembly and disassembly of gimbals and photographic devices are limited.

### SUMMARY

In order to solve the above technical problem, the present disclosure provides a gimbal and a photographic device stand.

A first aspect of the present disclosure provides a gimbal, including:
a base, provided with an external connection portion configured to connect a photographic device;
a tilt mechanism, including a tilt body and a first connection rod, where the tilt body is connected to the base and configured to tilt around the first connection rod;
a pan mechanism, including a pan body and a second connection rod, where the pan body is configured to pan around the second connection rod, and the second connection rod is connected to a side wall of the first connection rod; and
a spherical mechanism, including a fixed body and a third connection rod, where the fixed body is connected to the pan body and configured to rotate spherically on an upper end of the third connection rod, and a lower end of the third connection rod is configured to connect an external stand.

In the technical solution of the gimbal, during use, the photographic device is connected to the external connection portion of the base. The tilt body is rotated relative to the first connection rod so as to drive the base and the photographic device to tilt. The second connection rod is rotated relative to the pan body so as to drive the tilt mechanism, the base, and the photographic device to pan. The fixed body is rotated relative to the third connection rod so as to drive the pan mechanism, the tilt mechanism, the base, and the photographic device to rotate spherically. The design enables control of the orientation of the photographic device from multiple directions and adjustment of the shooting angle of the photographic device, so as to improve the quality of the photographic work.

A second aspect of the present disclosure provides a gimbal, including:
a base, provided with an external connection portion configured to connect a photographic device;
a tilt mechanism, including a tilt body and a first connection rod, where the tilt body is connected to the base and configured to tilt around the first connection rod; and
a rocker arm, connected to the tilt body, and including a functional assembly, where the functional assembly includes a handle and a screwdriver bit; the handle is provided with a mounting port and a mounting chamber; the screwdriver bit is provided in the mounting chamber; the functional assembly is detachable from the tilt body; and when the functional assembly is detached from the tilt body, the screwdriver bit is detached from the mounting chamber and mounted in the mounting port.

In the technical solution gimbal, when it is not necessary to use the screwdriver for assembly and disassembly, the rocker arm serves as a rotating rod for the tilt body. For example, the rocker arm is swung to adjust the tilt angle of the photographic device mounted on the tilt body. The functional assembly of the rocker arm is detachable from the tilt body, and the functional assembly includes the handle and the screwdriver bit. Thus, when the functional assembly is detached from the tilt body, the handle and the screwdriver bit can be combined to form a screwdriver for assembly and disassembly. Therefore, the gimbal can adjust the shooting angle of the photographic device without the need for an external device, and can provide a tool for assembly and disassembly.

A third aspect of the present disclosure provides a photographic device stand, including:
a gimbal, including a base, a tilt mechanism, a pan mechanism, and a spherical mechanism, where the base is provided with an external connection portion configured to connect a photographic device; the tilt mechanism includes a tilt body and a first connection rod; the tilt body is connected to the base and configured to tilt around the first connection rod; the pan mechanism includes a pan body and a second connection rod; the pan body is configured to pan around the second connection rod; the second connection rod is connected to a side wall of the first connection rod; the spherical mechanism includes a fixed body and a third connection rod; the fixed body is connected to the pan body and configured to rotate spherically on an upper end of the third connection rod; and a lower end of the third connection rod is configured to connect an external stand; and
a support frame, connected to an end of the third connection rod away from the fixed body.

In the technical solution of the photographic device stand, during use, the photographic device is connected to the external connection portion of the base. The tilt body is rotated relative to the first connection rod so as to drive the base and the photographic device to tilt. The second connection rod is rotated relative to the pan body so as to drive the tilt mechanism, the base, and the photographic device to pan. The fixed body is rotated relative to the third connection rod so as to drive the pan mechanism, the tilt mechanism, the base, and the photographic device to rotate spherically. The design enables control of the orientation of the photographic device from multiple directions and adjustment of the shooting angle of the photographic device, so as to improve the quality of the photographic work.

A fourth aspect of the present disclosure provides a photographic device stand, including:
a gimbal, including a base, a tilt mechanism, and a rocker arm, where the base is provided with an external connection portion configured to connect a photographic device; the tilt mechanism includes a tilt body and a first connection rod; the tilt body is connected to the base and configured to tilt around the first connection rod; the rocker arm is connected to the tilt body, and includes a functional assembly; the functional assembly includes a handle and a screwdriver bit; the handle is provided with a mounting port and a mounting chamber; the screwdriver bit is provided in the mounting chamber; the functional assembly is detachable from the tilt body; and when the functional assembly is detached from the tilt body, the screwdriver bit is detached from the mounting chamber and mounted in the mounting port; and
a support frame, connected to an end of the first connection rod away from the base.

In the technical solution of the photographic device stand, when it is not necessary to use the screwdriver for assembly and disassembly, the rocker arm serves as a rotating rod for the tilt body. For example, the rocker arm is swung to adjust the tilt angle of the photographic device mounted on the tilt body. The functional assembly of the rocker arm is detachable from the tilt body, and the functional assembly includes the handle and the screwdriver bit. Thus, when the functional assembly is detached from the tilt body, the handle and the screwdriver bit can be combined to form a screwdriver for assembly and disassembly.

### BRIEF DESCRIPTION OF THE DRAWINGS

To describe the technical solutions in the embodiments of the present application or in the prior art more clearly, the following briefly describes the drawings required for describing the embodiments or the prior art. Apparently, the drawings in the following description show some embodiments of the present application, and those of ordinary skill in the art may still derive other drawings from these drawings without creative efforts.

FIG. 1 is an overall structural diagram of a gimbal according to an embodiment of the present disclosure;

FIG. 2 is an overall structural diagram of the gimbal according to the embodiment of the present disclosure;

FIG. 3 is an overall side view of the gimbal according to the embodiment of the present disclosure;

FIG. 4 is a structural diagram of a tilt mechanism and a pan mechanism that are connected to each other according to the embodiment of the present disclosure;

FIG. 5 is an overall structural diagram of the tilt mechanism according to the embodiment of the present disclosure;

FIG. 6 is an overall structural diagram of a spherical mechanism according to the embodiment of the present disclosure;

FIG. 7 is a partial structural diagram of the spherical mechanism according to the embodiment of the present disclosure;

FIG. 8 is a top view of the overall structure shown in FIG. 7;

FIG. 9 is a top view of the overall structure, with a spherical head removed, shown in FIG. 8;

FIG. 10 is an overall structural diagram of a photographic device stand according to an embodiment of the present disclosure;

FIG. 11 is a stereoscopic view of a gimbal according to another embodiment of the present disclosure;

FIG. 12 is an exploded view of the gimbal shown in FIG. 11;

FIG. 13 is an exploded view of a handle of the gimbal shown in FIG. 12, and

FIG. 14 is a structural diagram of a screwdriver bit of the gimbal shown in FIG. 12.

### REFERENCE NUMERALS

1. photographic device stand;
10. gimbal; and
100. base; 110. external connection portion; 120. control button; 200. tilt mechanism; 210. tilt body, 211 groove; 220. first connection rod; 230. first control element; 300. pan mechanism; 310. pan body; 320. second connection rod; 321. second protrusion; 330. second control element; 400. spherical mechanism; 410. fixed body; 411. holding space; 412. socket; 413. guide groove; 420. third connection rod; 430. third control element; 431. fixed ring; 432. lever; 440. spherical head; 20. support frame; 21. support seat; 22. support leg; 2. gimbal body; 3. rocker arm; 4. linkage rod; 5. functional assembly; 6. handle; 3000. opening, 3001. end cover; 3001a connection portion; 3001b. limiting groove; 3001c anti-slip pattern; 3001d. first screw thread; 3002. mounting chamber; 3003. sleeve rod; 3003a. screwdriver mounting element; 3003b. mounting port; 3004. second screw thread; 301. screwdriver bit; 3010. first end; and 3011. second end.

### DETAILED DESCRIPTION OF THE EMBODIMENTS

The typical implementations embodying the features and advantages of the present disclosure are described in detail below. It should be understood that the present disclosure may have various changes in different implementations, which do not depart from the scope of the present disclosure. The description and drawings herein are essentially used for the purpose of explanation, rather than to limit the present disclosure.

In addition, terms such as “first” and “second” are used merely for a descriptive purpose, and should not be construed as indicating or implying relative importance, or implicitly indicating the number of indicated technical features. Therefore, the features defined by “first” and “second” can explicitly or implicitly include one or more features. In the description of the present disclosure, “multiple” means two or more, unless otherwise specifically defined.

In the description of the present disclosure, it should be noted that, unless otherwise clearly specified and defined, meanings of terms “arrange”, “mount”, “connected to”, “connected to”, and “communicate” should be understood in a board sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand specific meanings of the foregoing terms in the present disclosure based on a specific situation.

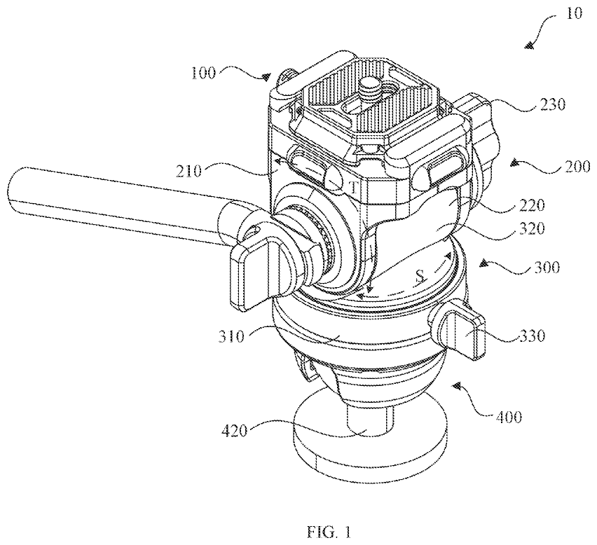

As shown in FIG. 1, the present disclosure provides gimbal 10, including base 100, tilt mechanism 200, pan mechanism 300, and spherical mechanism 400. The base 100 is provided with external connection portion 110 configured to connect a photographic device. The tilt mechanism 200 includes tilt body 210 and first connection rod 220. The tilt body 210 is connected to the base 100 and configured to tilt around the first connection rod 220. The pan mechanism 300 includes pan body 310 and second connection rod 320. The pan body 310 is configured to pan around the second connection rod 320. The second connection rod 320 is connected to a side wall of the first connection rod 220. The spherical mechanism 400 includes fixed body 410 and third connection rod 420. The fixed body 410 is connected to the pan body 310 and configured to rotate spherically on an upper end of the third connection rod 420. A lower end of the third connection rod 420 is configured to connect an external stand.

During use of the gimbal 10, the photographic device is connected to the external connection portion 110 of the base 100. The tilt body 210 is rotated relative to the first connection rod 220 so as to drive the base 100 and the photographic device to tilt. The second connection rod 320 is rotated relative to the pan body 310 so as to drive the tilt mechanism 200, the base 100, and the photographic device to pan. The fixed body 410 is rotated relative to the third connection rod 420 so as to drive the pan mechanism 300, the tilt mechanism 200, the base 100, and the photographic device to rotate spherically. The design enables control of the orientation of the photographic device from multiple directions and adjustment of the shooting angle of the photographic device, so as to improve the quality of the photographic work.

It should be noted that a rotation direction of the tilt body 210 is defined as a first direction (as indicated by the T arrow in FIG. 1), and a rotation direction of the pan body 310 is defined as a second direction (as indicated by the S arrow in FIG. 1). The first direction is at an angle to the second direction (the first direction is not parallel to the second direction).

Specifically, in this embodiment, the first direction and the second direction are perpendicular to each other (a length direction of the first connection rod 220 is perpendicular to a length direction of the second connection rod 320). In an ideal state, the first direction is perpendicular to a horizontal plane, and the second direction is parallel to the horizontal plane.

Understandably, the design of the first direction perpendicular to the horizontal plane and the second direction parallel to the horizontal plane refer to a state where the second connection rod 320 is perpendicular to the horizontal plane (the first connection rod 220 is parallel to the horizontal plane). When the spherical mechanism 400 drives the pan mechanism 300, the tilt mechanism 200, and the base 100 to rotate to other state, the first direction and the second direction are still perpendicular to each other, but the first direction is not perpendicular to the horizontal plane, and the second direction is not parallel to the horizontal plane.

It should also be noted that the tilt body 210 is rotatable for 0-180º in the first direction relative to the first connection rod 220 (i.e. the first connection rod 220 is rotatable for 0-180° in the first direction relative to the tilt body 210). The pan body 310 is rotatable for 0-360° in the second direction relative to the second connection rod 320 (i.e. the second connection rod 320 is rotatable for 0-360° in the second direction relative to the pan body 310).

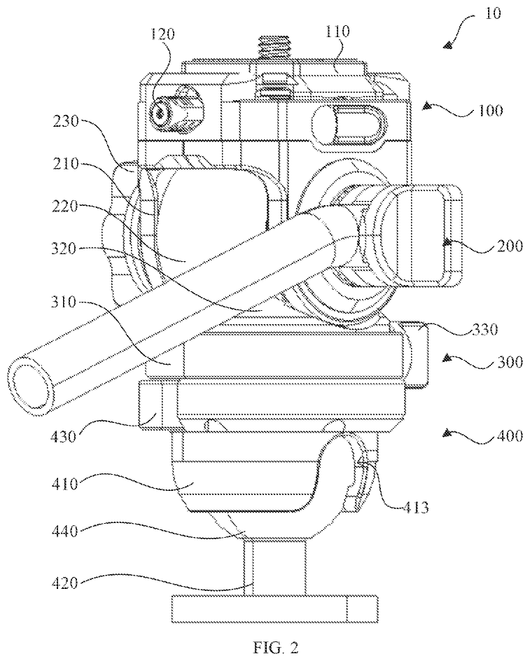

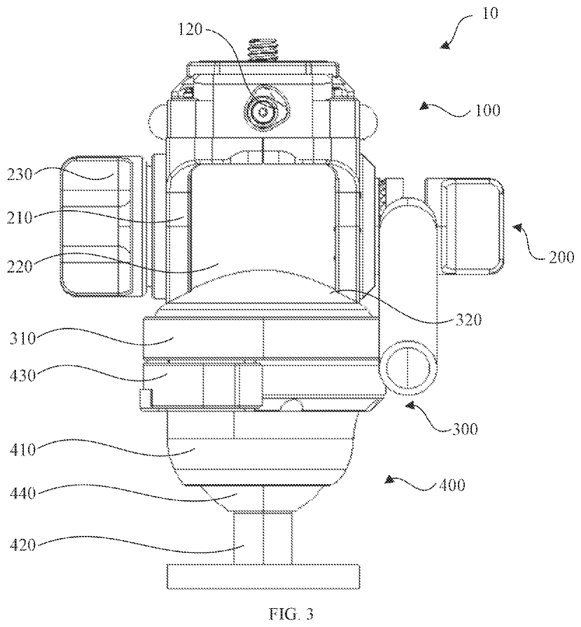

Furthermore, as shown in FIGS. 1 to 3, the external connection portion 110 includes two clamping elements that are movable close to or away (not shown in the figure) from each other. When the photographic device is placed on the external connection portion 110, the two clamping elements are moved close to each other to fix the photographic device. In addition, the base 100 is further provided with control button 120. When the control button 120 is pressed, the two clamping elements are moved away from each other, such that a user can remove the photographic device.

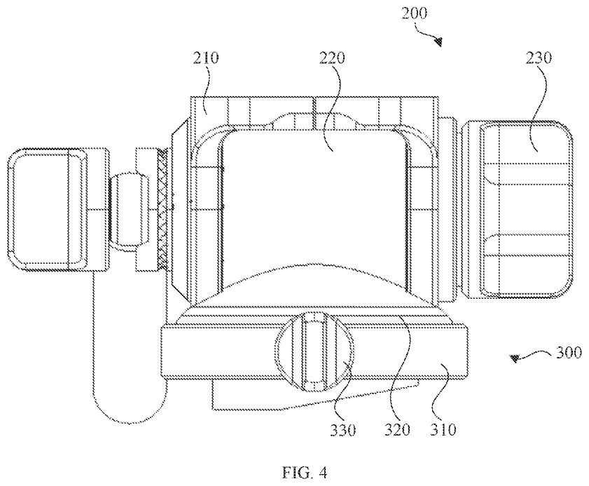

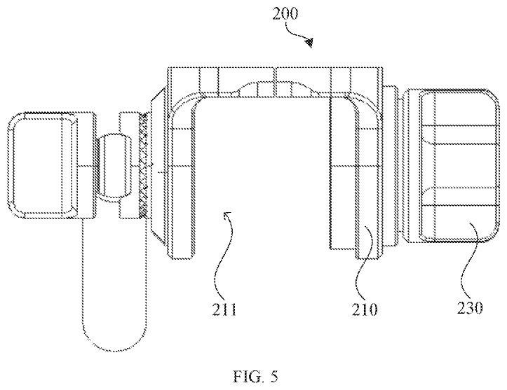

In an embodiment, as shown in FIGS. 4 and 5, groove 211 is formed on a side of the tilt body 210 away from the base 100. The first connection rod 220 includes two ends respectively abutted against the left side wall and the right side wall of the groove 211, and is rotatable relative to the tilt body 210. Damping of the groove 211 on the two ends of the first connection rod 220 is increased, which increases a resistance that the tilt body 210 needs to overcome when rotating relative to the first connection rod 220.

Therefore, the damping of the groove 211 on the two ends of the first connection rod 220 can be reduced to adjust a tilt angle (i.e., an angle in the first direction) of the tilt body 210, the base 100, and the external photographic device when needed. Alternatively, the damping of the groove 211 on the two ends of the first connection rod 220 can be increased to fix the tilt angle (i.e., the angle in the first direction) of the tilt body 210, the base 100, and the external photographic device when the position relationship between the tilt body 210 and the first connection rod 220 needs to be fixed.

It should be noted that there are many ways, such as bolt fixation and buckle fixation, to control the damping of the left side wall and the right side wall of the groove 211 on the two ends of the first connection rod 220.

Specifically, in this embodiment, the tilt mechanism 200 includes first control element 230. The first control element 230 is connected to an outer side wall of the tilt body 210 and configured to control the damping of the left side wall and/or the right side wall on the first connection rod 220. For example, the user can control the first control element 230 to rotate clockwise (or counterclockwise if needed, without limitation), so as to move the first control element 230 toward the first connection rod 220, thereby increasing the damping of the groove 211 on the ends of the first connection rod 220. On the contrary, the user can control the first control element 230 to rotate in an opposite direction so as to move the first control element 230 away from the first connection rod 220, thereby reducing the damping of the groove 211 on the ends of the first connection rod 220.

It should also be noted that the base 100 is connected to the tilt body 210. When it is necessary to adjust the tilt angle of the photographic device (i.e. the angle in the first direction), the first connection rod 220 is not rotated itself. In fact, the tilt body 210 is rotated relative to the first connection rod 220, so as to drive the base 100 and the photographic device to rotate together.

In an embodiment, as shown in FIG. 4, the pan mechanism 300 further includes second control element 330. The second control element 330 movably penetrates the pan body 310 and is configured to be abutted against a side wall of the second connection rod 320.

Therefore, the second control element 330 can be moved away from the second connection rod 320 so as to reduce or eliminate an abutting force (i.e. damping) between the second control element 330 and the second connection rod 320. This design facilitates adjusting the angle of the second connection rod 320, the tilt mechanism 200, the base 100, and the external photographic device in the second direction. Of course, the second control element 330 can also be moved close to the second connection rod 320 so as to increase the abutting force (i.e. damping) between the second control element 330 and the second connection rod 320. This design facilitates fixing the angle of the second connection rod 320, the tilt mechanism 200, the base 100, and the external photographic device in the second direction after adjustment.

Specifically, in this embodiment, the second control element 330 penetrates a portion of the pan body 310, and is bolted with the pan body 310. The design facilitates the movement of the second control element 330 relative to the pan body 310. In addition, the design can also maintain the constraint on the second control element 330 after the second control element 330 is disengaged from the second connection rod 320, so as to avoid the separation of the second control element 330 from the pan body 310, thereby facilitating subsequent operations.

Furthermore, as shown in FIGS. 4 and 5, the first connection rod 220 extends toward a side wall of the second connection rod 320 to form a first protrusion (not shown in the figure). The second connection rod 320 is provided with two second protrusions 321 toward the first connection rod 220. The two second protrusions 321 are configured to clamp two opposite sides of the first protrusion so as to firmly secure the second connection rod 320 and the first connection rod 220.

It should be noted that during the mounting and use of the gimbal 10, the photographic device is located at an upper end of the base 100, the base 100 is located at an upper end of the tilt mechanism 200, the tilt mechanism 200 is located at an upper end of the pan mechanism 300, the pan mechanism 300 is located at an upper end of the spherical mechanism 400, and the spherical mechanism 400 is located at an upper end of the external stand. Therefore, the two second protrusions 321 of the second connection rod 320 can effectively support the first connection rod 220 and drive the first connection rod 220, the tilt mechanism 200, the base 100, and the external photographic device to rotate together during the rotation process of the second connection rod 320.

Understandably, when it is necessary to adjust a pan angle of the photographic device (i.e. an angle in the second direction), the pan body 310 is not rotated itself. In fact, the second connection rod 320 is rotated relative to the pan body 310 so as to drive the tilt mechanism 200, the base 100, and the photographic device to rotate together.

Furthermore, a mark (not shown in the figure) may be provided on the second connection rod 320, and a scale (not shown in the figure) may be provided on a periphery of the pan body 310. When the photographic device is rotated in the second direction, the mark is rotated accordingly, corresponding to the scale, to display a rotation angle in real time. The scale on the periphery of the pan body 310 is 0-360°.

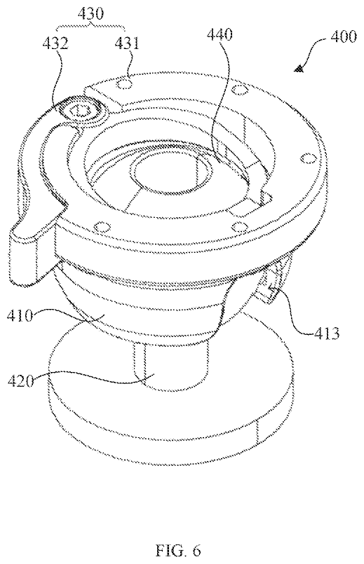

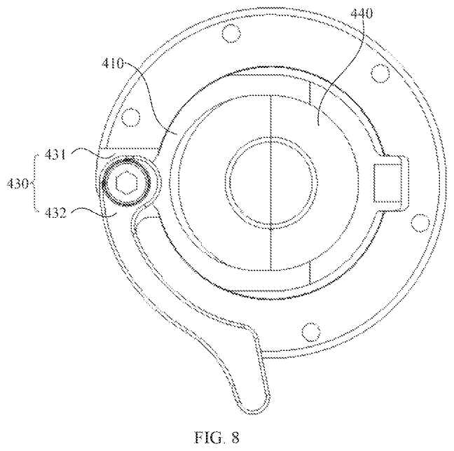

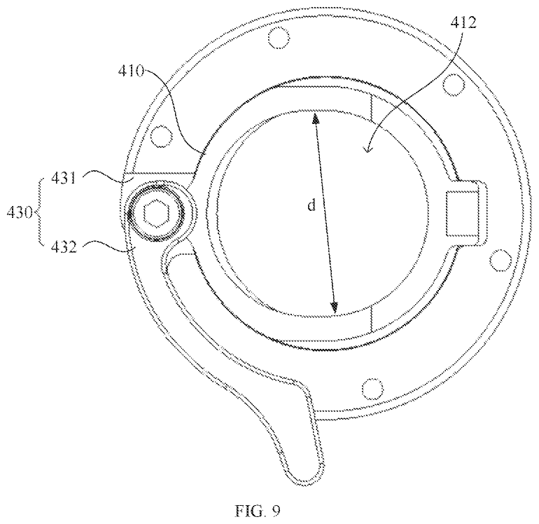

In an embodiment, as shown in FIGS. 6 to 9, the spherical mechanism 400 further includes spherical head 440. The spherical head 440 is connected to the upper end of the third connection rod 420. The end of the fixed body 410 facing the third connection rod 420 is provided with holding space 411 for holding the spherical head 440. The spherical head 440 is rotatable in the holding space 411.

Therefore, the fixed body 410 is rotatable along a spherical surface of the spherical head 440, thereby flexibly adjusting the orientation of the fixed body 410, the pan mechanism 300, the tilt mechanism 200, the base 100, and the photographic device.

The end of the fixed body 410 facing the third connection rod 420 is provided with socket 412. The maximum diameter d of the socket 412 is smaller than the diameter D of the spherical head 440. The design facilitates the rotation of the spherical head 440 with the third connection rod 420, and also prevents the spherical head 440 from detaching from the holding space 411 at the socket 412, improving the flexibility and stability of the spherical mechanism 400.

Understandably, larger maximum diameter d of the socket 412 indicates a greater rotational space formed for the third connection rod 420, and a larger rotation range of the spherical head 440 and the third connection rod 420 relative to the fixed body 410, that is, a larger rotation range of the fixed body 410 with the pan mechanism 300, the tilt mechanism 200, the base 100, and the photographic device.

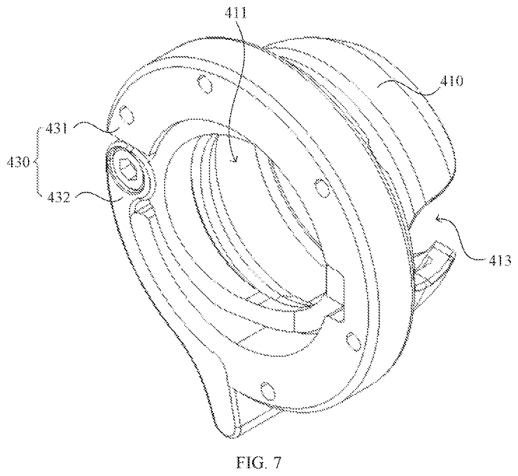

In an embodiment, as shown in FIGS. 6 and 7, a side wall of the fixed body 410 is provided with guide groove 413. The guide groove 413 is communicated with the socket 412. The third connection rod 420 is rotatable along a length direction of the guide groove 413 with the spherical head 440 as a center. Therefore, the third connection rod 420 is movable in the guide groove 413, thereby increasing the rotation range of the fixed body 410 relative to the spherical head 440 and the third connection rod 420.

It should be noted that the guide groove may be straight or curved, and its shape can be adjusted by the user when needed. Specifically, in this embodiment, the guide groove 413 is straight.

It should also be noted that in this embodiment, the lower end of the third connection rod 420 is connected to a flat plate, and a lower end of the flat plate can be placed on a desktop.

In an embodiment, as shown in FIGS. 6 to 9, the spherical mechanism 400 further includes third control element 430. The third control element 430 is movably connected to the fixed body 410 and configured to control at least partial damping of an inner side wall of the fixed body 410 on the spherical head 440. Therefore, the damping of the inner side wall of the fixed body 410 on the spherical head 440 can be increased through the third control element 430, so as to fix relative positions of the fixed body 410 and the spherical head 440. Alternatively, the damping of the inner side wall of the fixed body 410 on the spherical head 440 can be reduced through the third control element 430, so as to adjust the relative positions of the fixed body 410 and the spherical head 440, thereby facilitating adjustment of the orientation of the photographic device.

In an embodiment, as shown in FIGS. 6 to 9, the third control element 430 includes fixed ring 431 and lever 432. The fixed ring 431 is sleeved on a periphery of the fixed body 410. The lever 432 is rotatably connected to an outer side wall of the fixed ring 431, and is rotatable relative to the fixed ring 431. When the lever is rotated toward a locking position, the fixed ring 431 increases a compression force on the fixed body 410 to increase the damping of the inner side wall of the fixed body 410 on the spherical head 440. When the lever is rotated toward an unlocking position, the fixed ring 431 reduces the compression force on the fixed body 410 to reduce the damping of the inner side wall of the fixed body 410 on the spherical head 440.

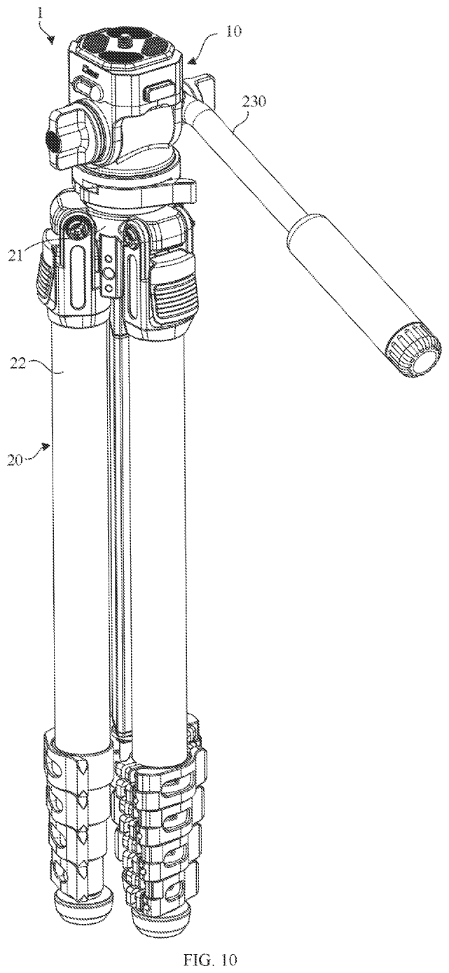

Referring to FIG. 10, the present disclosure further provides photographic device stand 1, including support frame 20 and the gimbal 10. The end of the third connection rod 420 away from the fixed body 410 is connected to the support frame 20. Therefore, when the gimbal 10 is mounted on the photographic device stand 1, the third connection rod 420 is connected to the support frame 20, thereby fixing the gimbal 10 with the photographic device stand.

Furthermore, the support frame 20 includes support seat 21 and support leg 22. The support seat 21 is connected below a second external connection end, and one end of each of the support legs 22 is rotatably connected to the support seat 21.

In the present disclosure, the positional and structural relationships between the components of the photographic device stand 1 in operation are further explained as follows.

A preparation process is performed. The end of the third connection rod 420 away from the spherical head 440 is fixed with the support frame 20 (generally, the third connection rod 420 is partially inserted into a connection hole of the support frame 20). The positions of the support legs 22 are adjusted so as to adjust the height and position of the gimbal 10. The photographic device is placed at the connection portion. The two clamping elements are controlled to move close to each other to grip an outer side wall of the photographic device, thereby firmly securing the photographic device to the gimbal 10.

The tilt angle is adjusted. The first control element 230 is rotated to reduce the damping of the groove 211 on the ends of the first connection rod 220. The user can rotate the tilt body 210 along the first direction with the first connection rod 220 as the axis (understandably, the user can also rotate the base 100 and the photographic device so as to adjust the tilt angle). When a target angle is reached, the first control element 230 is rotated in an opposite direction to fix the position of the tilt body 210 relative to the first connection rod 220. Thus, the adjustment of the tilt angle is completed.

The pan angle is rotated. The second control element 330 is rotated to move away from the second connection rod 320, so as to reduce or eliminate the damping of the second control element 330 on the second connection rod 320. The user can rotate the second connection rod 320 in the second direction (understandably, the user can also rotate the tilt mechanism 200, the base 100, and the photographic device to adjust the pan angle). When a target angle is reached (the adjustment can be assisted by observing the scale corresponding to the mark), the second control element 330 is rotated in an opposite direction, such that the second control element 330 moves toward the second connection rod 320. The damping of the second control element 330 on the second connection rod 320 is increased to fix the position of the second connection rod 320 relative to the pan body 310. Thus, the adjustment of the pan angle is completed.

A spherical angle is adjusted. The lever 432 is rotated toward the unlocking position to reduce the compression force of the fixed ring 431 on the fixed body 410, so as to reduce the damping of the inner side wall of the fixed body 410 on the spherical head 440. The user can rotate the fixed body 410 relative to the spherical head 440 (understandably, the user can also rotate the pan mechanism 300, the tilt mechanism 200, the base 100, and the photographic device to adjust the spherical angle). The user can also control the third connection rod 420 to move along the guide groove 413 (in fact, due to the fixed connection between the third connection rod 420 and the support frame, the guide groove 413 is controlled to move along the third connection rod 420). When a target position is reached, the lever 432 is rotated toward the locking position to increase the compression force of the fixed ring 431 on the fixed body 410. The damping of the inner side wall of the fixed body 410 on the spherical head 440 is increased so as to fix the position of the fixed body 410 relative to the spherical head 440. Thus, the spherical angle adjustment is completed.

### Second Embodiment of Gimbal

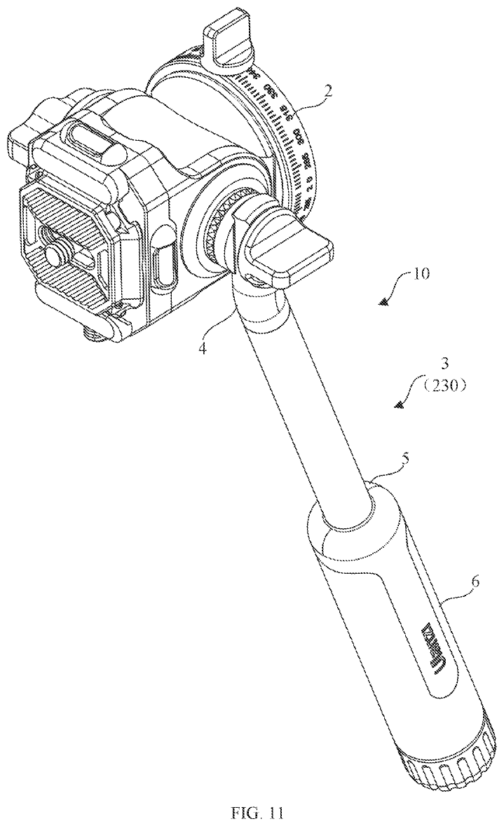

Referring to FIG. 11, FIG. 11 is a structural diagram of the gimbal 10 according to the second embodiment of the present disclosure. The gimbal 10 of this embodiment and the gimbal 10 of the first embodiment have basically the same structure, with the difference being that the structural form of the first control element 230 in this embodiment is different from that of the first control element 230 in the first embodiment. In addition, in this embodiment, the limitation of rotational freedom of the photographic device by the gimbal 10 is different from that in the first embodiment. In this embodiment, it is only required that the gimbal 10 can adjust the tilt angle of the photographic device. Regarding whether the gimbal 10 can adjust the panning and spherical rotation of the photographic device, it is not limited in this embodiment. In other words, the gimbal 10 of this embodiment is provided with at least the base 100 and the tilt mechanism 200.

Referring to FIG. 11, this embodiment provides gimbal 10. The gimbal 10 is configured to assist a photographic device in shooting. Specifically, the gimbal 10 is configured to adjust a shooting angle of the photographic device.

Referring to FIG. 11, the gimbal 10 includes gimbal body 2, rocker arm 3, and linkage rod 4. Two ends of the linkage rod 4 are respectively connected to the gimbal body 2 and the rocker arm 3 to indirectly connect the gimbal body 2 with the rocker arm 3. Thus, the rocker arm 3 is adjusted to rotate the gimbal body 2 so as to indirectly adjust the shooting angle of the photographic device. In other embodiments, the gimbal 10 may not include the linkage rod 4. The rocker arm 3 in this embodiment can be understood as at least a portion of the structure of the first control element 230 in the first embodiment.

The rocker arm 3 is configured to control the gimbal body 2 to rotate, so as to change the perspective of the photographic device. Specifically, a free end of the rocker arm 3 (i.e. an end away from the gimbal body 2) is configured to be gripped by the user. When the user grips the rocker arm 3, the rocker arm 3 can be driven to swing relative to the gimbal body 2, and the rocker arm 3 swings to change the shooting angle of the photographic device mounted on the gimbal body 2. The gimbal body 2 includes at least one of the base 100, the tilt mechanism 200, the pan mechanism 300, and the spherical mechanism 400 in the first embodiment. In this embodiment, for example, if the gimbal body 2 includes at least the tilt mechanism 200, the rocker arm 3 is connected to the tilt body 210 and configured to control the tilt body 210 to tilt around the first connection rod 220.

The rocker arm 3 is detachable from the gimbal body 2. When the rocker arm 3 is detached from the gimbal body 2, it can be used as a screwdriver tool. The screwdriver tool is configured to disassemble and assemble screw parts on the gimbal body 2 or on other device, achieving rapid assembly and disassembly without the need for an external tool.

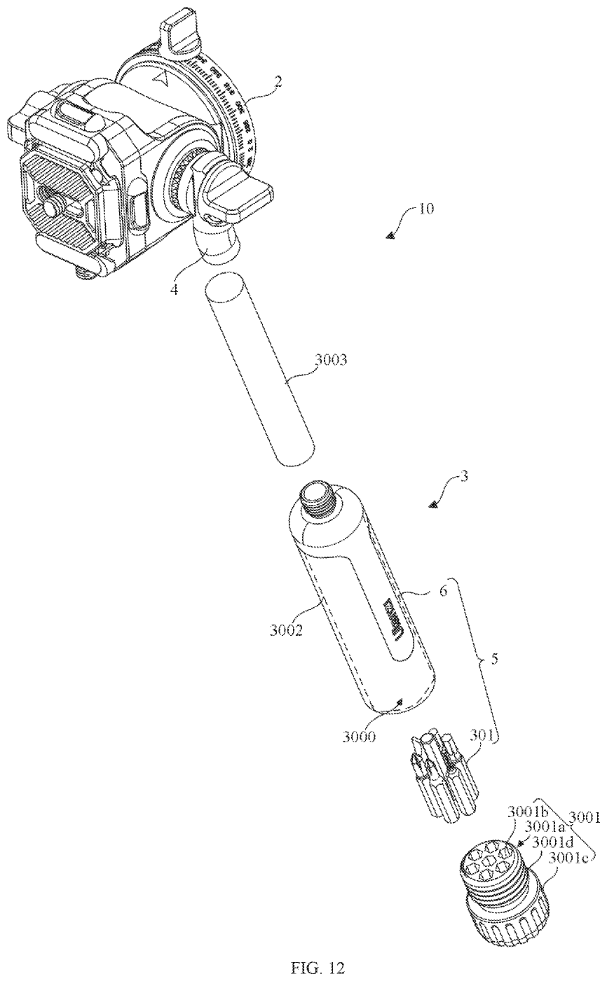

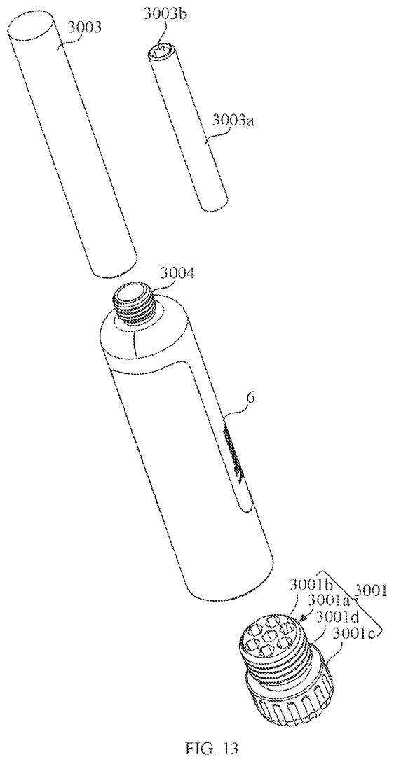

Referring to FIGS. 12 and 13, the rocker arm 3 includes functional assembly 5 and end cover 3001. The functional assembly 5 is provided with mounting chamber 3002 and mounting port 3003b. The mounting chamber 3002 is configured to store screwdriver bit 301 (detailed below), and the mounting port 3003b is configured to mount the screwdriver bit 301. FIG. 13 illustrates that the mounting chamber 3002 and the mounting port 3003b are respectively provided at two opposite ends in a length direction of the functional assembly 5. Understandably, in other embodiments, the mounting chamber 3002 and the mounting port 3003b may also be provided at a same end of the functional assembly 5. The relative positions of the mounting chamber 3002 and the mounting port 3003b are not limited in the present disclosure.

The end cover 3001 is configured to close the mounting chamber 3002. The end cover 3001 is detachable from the functional assembly 5 to open the mounting chamber 3002, allowing the screwdriver bit 301 stored in the mounting chamber 3002 to be mounted in the mounting port 3003b. Understandably, in some embodiments, the rocker arm 3 may not be provided with the end cover 3001. When the screwdriver bit 301 is not needed, the screwdriver bit 301 stored in the mounting chamber 3002 is always exposed to the mounting chamber 3002. Obviously, when the rocker arm 3 is provided with the end cover 3001, the end cover can prevent the screwdriver bit 301 from oxidizing and rusting. Therefore, the end cover 3001 provided for the rocker arm 3 can achieve a better usage effect.

Referring to FIGS. 12 and 13, in an embodiment, one end of the end cover 3001 is provided with anti-slip pattern 3001c. When the user manually tightens or loosens the end cover 3001, the anti-slip pattern 3001c increases a friction force between the user's hand and an outer surface of the end cover 3001, making it easier for the user to tighten or loosen the end cover 3001, thus achieving the assembly and disassembly of the end cover 3001. In other embodiments, the end cover 3001 may not be provided with the anti-slip pattern 3001c.

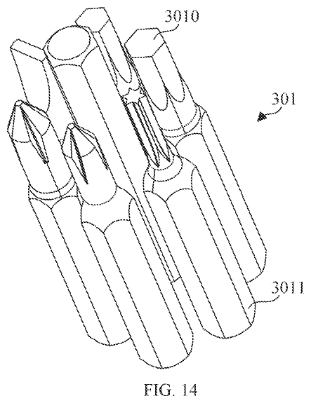

Referring to FIGS. 13 and 14, the functional assembly 5 includes handle 6 and the screwdriver bit 301. The screwdriver bit 301 is arranged in the mounting port 3003b to form the screwdriver tool to tighten or loosen the screw parts on the gimbal body 2 or on other device. In an embodiment, there are a plurality of screwdriver bits 301, and the screwdriver bits 301 are roughly hexagonal. In other embodiments, the number and shape of the screwdriver bit 301 are not limited. The screwdriver bit 301 includes first end 3010 and second end 3011. One of the first end 3010 and the second end 3011 is configured to be inserted into the mounting port 3003b to form the screwdriver tool, and the other is configured to adapt to the screw part on the gimbal body 2 or on other device. It should be noted that multiple first ends 3010 have different shapes, or multiple second ends 3011 have different shapes, so as to expand the scope of use of the screwdriver tool (detailed above). Referring to FIGS. 13 and 14, the handle 6 is detachably connected to the gimbal body 2. As shown in the figure, an end of the handle 6 is provided with a screw thread. Therefore, the handle 6 is threaded with the gimbal body 2. In other embodiments, the connection method between the handle 6 and the gimbal body 2 is not limited. Understandably, any detachable connection method of the handle 6 and the gimbal body 2 is within the protection scope of the present disclosure.

The handle 6 is configured to be adjusted to achieve the rotation of the gimbal body 2, thereby indirectly adjusting the shooting angle of the photographic device. Specifically, FIG. 12 illustrates that handle 6 is roughly cylindrical, making it easy to be gripped to change an angle between an axis of handle 6 and an axis of symmetry of the gimbal body 2, so as to drive the gimbal body 2 to rotate and indirectly adjust the shooting angle of the photographic device. In other embodiments, the shape of the handle 6 is not limited.

The handle 6 is further configured to hold the screwdriver bit 301. The handle 6 is provided with the mounting chamber 3002 and the mounting port 3003b. The handle 6 is provided with opening 3000 for the screwdriver bit 301 to enter and exit the mounting chamber 3002. An end of the handle 6 away from the opening 3000 is provided with the mounting port 3003b to achieve the mounting of the screwdriver bit 301.

In an embodiment, one of the mounting chamber 3002 and the screwdriver bit 301 is provided with a first magnet (not shown in the figure), and the other is provided with a second magnet (not shown in the figure). The first magnet is magnetically connected to the second magnet. One of the first magnet and the second magnet may be iron, and the other may be a magnet. The first magnet and the second magnet may also be two unlike magnets, respectively. Understandably, the screwdriver bit 301 can be magnetically attracted to an inner wall of the mounting chamber 3002. Specifically, the plurality of screwdriver bits 301 can be magnetically attracted to the inner wall of the mounting chamber 3002 around the handle 6. Obviously, the magnetic connection between the screwdriver bits 301 and the handle 6 is intended to facilitate the removal and placement of the screwdriver bits 301. In other embodiments, the screwdriver bits 301 may also be arranged in the mounting chamber 3002 through other means, and there may also be only one screwdriver bit 301 provided.

Referring to FIGS. 13 and 14, the end of handle 6 opposite to the opening 3000 is provided with the mounting port 3003b for mounting the screwdriver bit 301. More specifically, since the screwdriver bit 301 may be roughly hexagonal, a cross section of the mounting port 3003b may also be hexagonal. In other embodiments, the shape of the mounting port 3003b is not limited. It should be noted that in other embodiments, the end of the handle 6 opposite to the opening 3000 may not be provided with the mounting port 3003b.

In an embodiment, a peripheral side of the other end of the end cover 3001 is retracted to form connection portion 3001a. The connection portion 3001a is configured to connect the handle 6. A peripheral side of the connection portion 3001a is provided with first screw thread 3001d to thread the end cover 3001 with the handle 6. In other embodiments, the end cover 3001 may not be provided with the connection portion 3001a.

Specifically, the connection portion 3001a is provided with limiting groove 3001b to hold the screwdriver bit 301. Since there may be a plurality of screwdriver bits 301 and the screwdriver bits 301 may be roughly hexagonal, there may be a plurality of limiting grooves 3001b and the limiting grooves 3001b may be provided with a hexagonal cross-section. The limiting grooves 3001b are spaced on an outer side of the connection portion 3001a to hold the plurality of screwdriver bits 301. In other embodiments, the connection portion 3001a may not be provided with the limiting grooves 3001b, and other method may be used to arrange the screwdriver bits 301 in the handle 6.

Referring to FIGS. 13 and 14, in an embodiment, the handle 6 may further be detachably connected to sleeve rod 3003. Specifically, a periphery of the end of the handle 6 away from the end cover 3001 is provided with second screw thread 3004. Thus, the sleeve rod 3003 is threaded with the handle 6. The sleeve rod 3003 is directly or indirectly provided with the mounting port 3003b. Obviously, in other embodiments, the handle 6 may not be provided with the sleeve rod 3003. In other words, the mounting port 3003b may be provided at other position of the handle 6.

Referring to FIGS. 13 and 14, in an embodiment, the sleeve rod 3003 is provided with screwdriver mounting element 3003a and the mounting port 3003b. The sleeve rod 3003 is configured to sleeve the screwdriver mounting element 3003a. In other embodiments, the sleeve rod 3003 may not be provided with the mounting port 3003b, but the screwdriver mounting element 3003a is provided with the mounting port 3003b to mount the screwdriver bit 301 so as to form the screwdriver tool.

The sleeve rod 3003 is provided with the screwdriver mounting element 3003a The screwdriver mounting element 3003a is configured to mount the screwdriver bit 301. More specifically, one of two ends of the screwdriver mounting element 3003a is detachably connected to the handle 6 to separate the screwdriver mounting element 3003a from the gimbal 10, and the other is provided with the mounting port 3003b to mount the screwdriver bit 301. It should be noted that when the screwdriver mounting element 3003a independent of the gimbal 10 is provided with the screwdriver bit 301 to form the screwdriver tool, since the screwdriver mounting element 3003a is shorter than the handle 6, the screwdriver tool is easy to use. In other embodiments, the sleeve rod 3003 may be connected to the screwdriver mounting element 3003a through other means.

In this embodiment, when it is not necessary to use the screwdriver for assembly and disassembly, the rocker arm 3 serves as a rotating rod for the gimbal body 2 of the gimbal 10. For example, the rocker arm 3 is swung to adjust the shooting angle of the photographic device mounted on the gimbal body 2. The functional assembly 5 of the rocker arm 3 is detachable from the gimbal body 2, and the functional assembly 5 includes the handle 6 and the screwdriver bit 301. Thus, when the functional assembly 5 is detached from the gimbal body 2, the handle 6 and the screwdriver bit 301 can be combined to form a screwdriver for assembly and disassembly. Therefore, the gimbal 10 can adjust the shooting angle of the photographic device without the need for an external device, and can provide a tool for assembly and disassembly.

The present disclosure is described above with reference to several typical implementations. It should be understood that the terms used herein are intended for illustration, rather than limiting. The present disclosure may be specifically implemented in many forms without departing from the spirit or essence of the present disclosure. Therefore, it should be understood that the above embodiments are not limited to any of the above-mentioned details, but should be broadly interpreted according to the spirit and scope defined by the appended claims. Therefore, any changes and modifications falling within the claims or the equivalent scope thereof should be covered by the appended claims.

What is claimed is:

1. A gimbal, comprising:
a base, provided with an external connection portion configured to connect a photographic device;
a tilt mechanism, comprising a tilt body and a first connection rod, wherein the tilt body is connected to the base and configured to tilt around the first connection rod;
a pan mechanism, comprising a pan body and a second connection rod, wherein the pan body is configured to pan around the second connection rod, and the second connection rod is connected to a side wall of the first connection rod; and
a spherical mechanism, comprising a fixed body and a third connection rod, wherein the fixed body is connected to the pan body and configured to rotate spherically on an upper end of the third connection rod, and a lower end of the third connection rod is configured to connect an external stand.

2. The gimbal according to claim 1, wherein a side of the tilt body is provided with a groove, wherein the side of the tilt body is away from the base; and the first connection rod comprises two ends respectively abutted against a left side wall and a right side wall of the groove, and the first connection rod is rotatable relative to the tilt body.

3. The gimbal according to claim 2, wherein the tilt mechanism further comprises a first control element; the first control element is connected to an outer side wall of the tilt body and configured to control damping of the left side wall and/or the right side wall on the first connection rod.

4. The gimbal according to claim 3, wherein the first control element comprises a rocker arm; the rocker arm comprises a handle and a screwdriver bit; the handle is provided with a mounting port and a mounting chamber; the screwdriver bit is provided in the mounting chamber; the handle is detachable from the tilt body; and when the handle is detached from the tilt body, the screwdriver bit is detached from the mounting chamber and mounted in the mounting port.

5. The gimbal according to claim 1, wherein the pan mechanism further comprises a second control element; and the second control element movably penetrates the pan body and is configured to be abutted against a side wall of the second connection rod.

6. The gimbal according to claim 1, wherein the spherical mechanism further comprises a spherical head; the spherical head is connected to the upper end of the third connection rod; an end of the fixed body, is provided with a holding space for holding the spherical head, wherein the end of the fixed body faces the third connection rod; and the spherical head is rotatable in the holding space.

7. The gimbal according to claim 6, wherein the end of the fixed body is provided with a socket; and a maximum diameter d of the socket is smaller than a diameter D of the spherical head.

8. The gimbal according to claim 7, wherein a side wall of the fixed body is provided with a guide groove; the guide groove is communicated with the socket; and the third connection rod is rotatable along a length direction of the guide groove with the spherical head as a center.

9. The gimbal according to claim 6, wherein the spherical mechanism further comprises a third control element; the third control element is movably connected to the fixed body and configured to control at least partial damping of an inner side wall of the fixed body on the spherical head.

10. The gimbal according to claim 9, wherein the third control element comprises a fixed ring and a lever; the fixed ring is sleeved on a periphery of the fixed body; and the lever is rotatably connected to an outer side wall of the fixed ring, and the lever is rotatable relative to the fixed ring;
when the lever is rotated toward a locking position, the fixed ring increases a compression force on the fixed body to increase the damping of the inner side wall of the fixed body on the spherical head; and
when the lever is rotated toward an unlocking position, the fixed ring reduces the compression force on the fixed body to reduce the damping of the inner side wall of the fixed body on the spherical head.

11. A gimbal, comprising:
a base, provided with an external connection portion configured to connect a photographic device;
a tilt mechanism, comprising a tilt body and a first connection rod, wherein the tilt body is connected to the base and configured to tilt around the first connection rod; and
a rocker arm, connected to the tilt body, and comprising a functional assembly, wherein the functional assembly comprises a handle and a screwdriver bit; the handle is provided with a mounting port and a mounting chamber; the screwdriver bit is provided in the mounting chamber; the functional assembly is detachable from the tilt body; and when the functional assembly is detached from the tilt body, the screwdriver bit is detached from the mounting chamber and mounted in the mounting port.

12. The gimbal according to claim 11, wherein the rocker arm further comprises an end cover; and the end cover is configured to be connected to or detached from the handle; and
the end cover is provided with the screwdriver bit; when the end cover is connected to the handle, the screwdriver bit is concealed in the mounting chamber to achieve storage of the screwdriver bit in the mounting chamber; and when the end cover is detached from the handle, the screwdriver bit is detached from the mounting chamber together with the end cover.

13. The gimbal according to claim 12, wherein a peripheral side of the end cover is provided with a screw thread, allowing the end cover to be threaded with or detached from the handle, so as to drive the screwdriver bit to enter or exit the mounting chamber; and when the end cover is threaded with the handle, the end cover is abutted against the handle to close the mounting chamber.

14. The gimbal according to claim 12, wherein the end cover is provided with a limiting groove for holding the screwdriver bit, and a number of the limiting groove corresponds to a number of the screwdriver bit.

15. The gimbal according to claim 11, wherein the screwdriver bit is configured to be magnetically attracted to a wall of the mounting chamber, and the screwdriver bit is further configured to overcome a magnetic attraction to be mounted in the mounting port.

16. The gimbal according to claim 11, further comprising a linkage rod, wherein the linkage rod comprises two ends respectively connected to the tilt body and the handle;
the handle further comprises a screwdriver mounting element; and the screwdriver mounting element is configured to be connected to or detached from the handle, so as to assemble or disassemble the screwdriver mounting element; and
the screwdriver mounting element is provided with the mounting port for mounting the screwdriver bit.

17. The gimbal according to claim 16, wherein the handle further comprises a sleeve rod;
the sleeve rod comprises a first end threaded with the handle and a second end provided with the linkage rod; and the sleeve rod is configured to mount the screwdriver mounting element.

18. The gimbal according to claim 11, further comprising a linkage rod, wherein the linkage rod comprises two ends respectively connected to the tilt body and the handle; and
a first end of the handle is provided with the mounting port, wherein the first end of the handle is adjacent to the linkage rod.

19. The gimbal according to claim 18, wherein a second end of the handle is provided with an opening, wherein the second end of the handle is configured for the screwdriver bit to enter or exit the mounting chamber; and the first end of the handle is provided with the mounting port, wherein the first end of the handle is away from the opening.

20. The gimbal according to claim 11, wherein the functional assembly comprises a plurality of screwdriver bits, and the plurality of screwdriver bits have different specifications.

21. A photographic device stand, comprising:
a gimbal, comprising a base, a tilt mechanism, a pan mechanism, and a spherical mechanism, wherein the base is provided with an external connection portion configured to connect a photographic device; the tilt mechanism comprises a tilt body and a first connection rod; the tilt body is connected to the base and configured to tilt around the first connection rod; the pan mechanism comprises a pan body and a second connection rod; the pan body is configured to pan around the second connection rod; the second connection rod is connected to a side wall of the first connection rod; the spherical mechanism comprises a fixed body and a third connection rod; the fixed body is connected to the pan body and configured to rotate spherically on an upper end of the third connection rod; and a lower end of the third connection rod is configured to connect an external stand; and
a support frame, connected to an end of the third connection rod, wherein the end of the third connection rod is away from the fixed body.

22. A photographic device stand, comprising:
a gimbal, comprising a base, a tilt mechanism, and a rocker arm, wherein the base is provided with an external connection portion configured to connect a photographic device; the tilt mechanism comprises a tilt body and a first connection rod; the tilt body is connected to the base and configured to tilt around the first connection rod; the rocker arm is connected to the tilt body, and the rocker arm comprises a functional assembly; the functional assembly comprises a handle and a screwdriver bit; the handle is provided with a mounting port and a mounting chamber; the screwdriver bit is provided in the mounting chamber; the functional assembly is detachable from the tilt body; and when the functional assembly is detached from the tilt body, the screwdriver bit is detached from the mounting chamber and mounted in the mounting port; and
a support frame, connected to an end of the first connection rod, wherein the end of the first connection rod is away from the base.
